(19) United States
(12) Patent Application Publication
(10) Pub. No.: US 2016/0132270 A1
(43) Pub. Date: May 12, 2016

(54) INFORMATION PROCESSING DEVICE, INFORMATION PROCESING METHOD, AND PROGRAM

(71) Applicant: FIXSTARS CORPORATION, Tokyo (JP)

(72) Inventor: Satoshi MIKI, Tokyo (JP)

(73) Assignee: Fixstars Corporation, Tokyo (JP)

(21) Appl. No.: 14/784,637

(22) PCT Filed: Mar. 10, 2014
(86) PCT No.: PCT/JP2014/056137

§ 371 Date: Jan. 20, 2016

(30) Foreign Application Priority Data
Apr. 15, 2013 (JP) 2013-084488

(51) Int. Cl. G06F 3/06

(52) U.S. Cl. CPC G06F 3/0643; G06F 3/0604; G06F 3/0631; G06F 3/0679

(57) ABSTRACT

An information processing device including an NV memory that is a non-volatile recording medium, a file system unit that manages one or more files stored in the NV memory, and a memory management unit that allocates one or more areas of the NV memory, that are ready to be used by the file system unit to store a file, to a running process in response to a request from the running process. The file system unit accesses areas of the NV memory storing unused area management data sets for managing unused areas of the NV memory. The unused area management data sets have data structure that is suitable for characteristic features of the NV memory. When the NV memory is used both as a main memory and a storage, time required for allocating memory blocks to a process is shortened.

### TECHNICAL FIELD

This invention relates to an information processing device using a non-volatile memory.

### BACKGROUND

There are several types of non-volatile memory (non-volatile memory is referred to as NV memory hereinafter) such as SSD (see non-patent document 1) and EEPROM (see non-patent document 2).

Non-patent Document 1: “What is SSD?” [online], IT Glossary e-Words, Searched on Mar. 19, 2013, Internet,[URL: http://e-words.jp/w/SSD.html]

Non-patent Document 2: “What is EEPROM?”[online], IT Glossary e-Words, Searched on Mar. 19, 2013, Internet,[URL: http://e-words.jp/w/EEPROM.html]

As a result of several studies conducted in recent years for utilizing an NV memory as a main memory and utilizing a main memory as a storage, use of an NV memory as both a main memory and a storage without the area of the NV memory being divided into an area used as a main memory and an area used as a storage has been realized. When an NV memory is used as both a main memory and a storage, a main memory and a storage may be integrated, i.e. they can be treated as a memory without being distinguished from each other. If a main memory and a storage are integrated, efficiency of memory management in a system may be improved. However, it takes comparatively long time for memory blocks to be allocated to a process as a main memory.

### SUMMARY

A first embodiment of the present invention is an information processing device comprising an NV memory that is a non-volatile recording medium, a file system unit that manages one or more files stored in the NV memory, and a memory management unit that secures one or more areas of the NV memory that are ready to be used by the file system unit to store a file, and allocates the secured one or more areas to a running process in response to a request from the running process, wherein the file system unit accesses areas of the NV memory storing unused area management data sets for managing unused areas of the NV memory, the unused area management data sets having data structure that is suitable for characteristic features of the NV memory, and the data structure that is suitable for characteristic features of the NV memory is configured for using areas of the NV memory that are not physically continuous as areas that are logically continuous.

According to the above-mentioned information processing device, when an NV memory is used both as a main memory and a storage, time required for allocating memory blocks to a process may be shortened.

A second embodiment of the present invention is the information processing device according to the first embodiment, wherein the data structure contains list structure or data structure using list structure for managing memory.

According to the above-mentioned information processing device, when an NV memory is used both as a main memory and a storage, time required for allocating memory blocks to a process may be shortened.

A third embodiment of the present invention is the information processing device according to the first embodiment or the second embodiment, wherein the file system unit writes a file of a size conforming to a size requested by the running process to unused areas of the NV memory in response to the request from the running process, and the memory management unit allocates the unused areas of the NV memory where the file is written by the file system unit to the running process in response to the request from the running program.

According to the above-mentioned information processing device, when an NV memory is used both as a main memory and a storage, time required for allocating memory blocks to a process may be shortened.

According to the present invention, when an NV memory is used as both a main memory and a storage, time required for allocating memory blocks to a process may be shortened.

### BRIEF EXPLANATION OF THE DRAWINGS

FIG. 1 is a block diagram showing information processing device 1 of embodiment 1.

FIG. 2 illustrates examples of unused area management data sets in embodiment 1.

FIG. 3 is a flow chart showing an overview of processes conducted by information processing device 1 of embodiment 1.

FIG. 4 is a flow chart showing processes for allocating an area to a process and for releasing an area from a process in embodiment 1.

FIG. 5 illustrates examples of file management data sets in embodiment 1.

FIG. 6 illustrates an example of status change of unused area management data sets in embodiment 1.

FIG. 7 illustrates examples of file management data sets in embodiment 1.

FIG. 8 illustrates examples of memory management data sets in embodiment 1.

FIG. 9 illustrates an example of status change of unused area management data sets in embodiment 1.

FIG. 10 illustrates an example of structure of a system in embodiment 1.

FIG. 11 illustrates an example of a command for changing a threshold value in embodiment 1.

FIG. 12 shows graphs showing a result of an experiment for comparing costs of memory allocation in embodiment 1.

FIG. 13 shows graphs showing a result of an experiment for comparing costs of memory allocation in embodiment 1.

FIG. 14 illustrates results of measurements of a number of run commands and a number of cache misses.

FIG. 15 illustrates an outline of a computer system in embodiment 1.

FIG. 16 is a block diagram of a computer system in embodiment 1.

### DETAILED DESCRIPTION

An information processing device according to an exemplary embodiment of the present invention will be explained below referring to figures. In the embodiment explained below, components having the same reference number perform similarly, and the performance of the components may not be explained repeatedly. Formats of data, contents of data, etc. used in the following explanation of the exemplary embodiment are examples, and any other formats, contents, etc., may be used for the present invention.

### Embodiment 1

In this exemplary embodiment, information processing device 1 is explained. Information processing device 1 uses an NV memory as both a main memory and a storage without dividing an area of the NV memory into an area used as a main memory and an area used as a storage, and manages an area used as a main memory by use of a file system. In this application, a storage is a so-called secondary storage device or an auxiliary storage device, and a main memory is a so-called primary storage device or main storage device. An area used as a main memory means an area used by an active process.

FIG. 1 is a block diagram of information processing device 1 of the present embodiment. Information processing device 1 comprises NV memory 11, receiving unit 12, file system unit 13 and memory management unit 14. File system unit 13 includes unused area management information storage unit 131 and file management information storage unit 132. Memory management unit 14 includes memory management information storage unit 141 and allocation unit 142.

File system unit 13 and memory management unit 14 of information processing device 1 of the present embodiment may be realized by a so-called OS or a kernel of the OS.

NV memory 11 is a non-volatile storage medium. NV memory 11 may be, for example, a PCM (Phase Change Memory), an MRAM, a ReMAM, an EEPROM, a flash memory, etc. NV memory 11 is not limited in its shape, type, etc., and any non-volatile memory may be used as NV memory 11. Preferably, NV memory 11 is a non-volatile memory accessible in units of a byte.

NV memory 11 has one or more areas. (In the following description, “areas” means “one or more areas.”) An area may be referred to using terms such as a block, a page, etc. In the areas, data used by processes are stored. A process may be referred to using other terms such as a job, a task, a thread, etc. Data stored in NV memory 11 may contain a file, a part of a file, a value substituted for a variable, etc. A size (capacity) of an area is predetermined. The size of an area is, for example, 4 KB (kilobytes), 512 B (bytes), etc. An area is recognized as a block by file system unit 13, and it is recognized as a page by memory management unit 14. In this embodiment, a size of a block and a size of a page are the same. The size is preferably 4 KB.

In the following explanation, each area of NV memory 11 is referred to as “an area of NV memory 11” or “an area.” An area storing no data or an area that is allowed to store new data is referred to as an “unused area.” An area storing data or an area that is not allowed to store new data is referred to as a “used area.”

In general, NV memory 11 is disposed in a physical space, the physical space having continuous physical addresses. “A memory is disposed in a physical space” means that each area of a memory is associated with one of the continuous physical addresses. Namely, each area of NV memory 11 is identified by a physical address. An area of NV memory 11 may be indirectly identified by, for example, a logical address or a virtual address instead of a physical address.

Each area of NV memory 11 is identified by an area identifier. An area identifier is information for identifying an area of NV memory 11. An area identifier is, for example, a physical address, a logical address, or a virtual address. Namely, an area identifier is information that directly or indirectly identifies an area of NV memory 11. Each area identifier usually indicates a certain position in an order of areas.

Disposal of NV memory 11 to a physical address space is carried out by, for example, file system unit 13. The disposal may be carried out by, for example, memory management unit 14 or a memory disposing unit that is not shown in FIG. 1.

Receiving unit 12 receives information such as an instruction. An instruction received by receiving unit 12 is, for example, an instruction of execution of a program, an instruction of execution of a process, an instruction of allocation of an area to a process, an instruction of an operation to a file, etc. Receiving unit 12 may receive information such as a command, a parameter of the command, etc. Information received by receiving unit 12 is output from, for example, a program.

File system unit 12 is a file system. The file system is, for example, a disk file system or a local file system. The file system may support an XIP (eXecute-In-Place) system. Any type of file system may be adopted as file system unit 12 so long as it can manage files stored in NV memory 11. The file system is a PRAMFS (Persistent and Protected RAM File System), an Ext2 (Second Extended File system), a SCMFS (A File System for Storage Class Memory), etc. File system unit 13 uses NV memory 11 as storage for storing files. File system unit 13 may divide an area of NV memory 11 into plural blocks for using the area as storage for storing files.

It is preferable that the file system manages unused areas by use of data sets (referred to as “unused area management data sets” hereinafter) that have data structure suitable for characteristic features of NV memory 11. “Characteristic features of NV memory 11” may mean that NV memory 11 is capable of performing speedy random access; in other words, it is possible to read data from NV memory 11 and write data to NV memory 11. “Characteristic features of NV memory 11” may mean that NV memory 11 does not have data reading head or data writing head that are provided in HDD (Hard Disk Drive), and no seek time is required when data is accessed in NV memory 11. “Data structure suitable for characteristic features of NV memory 11” may mean that the data structure is configured for using areas of NV memory 11 that are not physically continuous as areas that are logically continuous.

“Areas that are physically continuous” means areas that are identified by area identifiers that are continuous. “Areas that are logically continuous” means areas that are identified by area identifiers that are not continuous but that are sequentially accessed.

“Data structure suitable for characteristic features of NV memory 11” may be data structure for managing memory that contain any one of list structure, tree structure, data structure using list structure or tree structure, etc. “Data structure using list structure or tree structure” may contain data structure for managing memory that is usually called “buddy system,” “buddy block allocator,” or “buddy algorithm ” Preferably, “data structure suitable for characteristic features of NV memory 11” may contain a singly-linked list. “Data structure suitable for characteristic features of NV memory 11” does not contain bitmap structure.

“To manage unused areas” means to record information indicating which areas of NV memory 11 are unused as unused area management data sets that have a predetermined data structure. Preferably, the predetermined data structure is the above-explained “data structure suitable for characteristic features of NV memory 11.” “To record” means to edit an unused area management data set stored in unused area management information storage unit 131, to add an unused area management data set to unused area management information storage unit 131, etc. “To edit a data set” may cover rewriting a data set, updating a data set, etc.

An unused area management data set is a data set for managing unused areas. An unused area management data set usually contains one or more area identifiers that identify one or more unused areas. An unused area management data set may contain an area identifier that identifies a first unused area of continuous unused areas. “Continuous unused areas” means unused areas that are physically continuous. One set of continuous unused areas is usually physically discontinuous with another set of continuous unused areas. Alternatively, an unused area management data set may contain area identifiers each of which identifies an unused area. In such a case, area identifiers are usually sorted in a predetermined order. The predetermined order is usually an ascending order.

An unused area management data set may contain a data set indicating a size of a set of unused areas (referred to as “a size data set” hereinafter). A size data set usually indicates a size of a set of continuous unused areas. Alternatively, an unused area management data set may contain size data sets each of which indicates a size of an unused area.

File system unit 13 usually edits an unused area management data set when a file is written to NV memory 11, when a file is deleted from NV memory, etc.

(1) When a file is to be written to NV memory 11, file system unit 13 usually acquires area identifiers identifying unused areas where the file should be written. More concretely, file system unit 13, for example, acquires a suitable number of area identifiers by use of unused area management data sets. “A suitable number of area identifiers” means a certain number of area identifiers that identify unused areas that can store the file. Namely, a size of unused areas identified by a suitable number of area identifiers is equal to or greater than a size of the file, and a difference between the size of unused areas and the size of the file is as small as possible. Area identifiers acquired by file system unit 13 are preferably continuous.

For example, it is assumed that each unused area management data set contains an area identifier identifying a first area of a set of continuous unused areas and a size data set indicating a size of the set of continuous unused areas. In this case, file system unit 13 selects, for example, an unused area management data set containing a size data set indicating a size equal to or greater than a size of the file to be written to NV memory 11, and acquires an area identifier contained in the selected unused area management data set. Then, file system unit 13 acquires a suitable number of area identifiers that identify continuous unused areas following an unused area identified by the area identifier contained in the selected unused area management data set.

For example, it is assumed that file system unit 13 selects an unused area management data set that contains an area identifier “0xF0000001” and a size data set indicating “80 KB.” It is also assumed that a size of each area is 4 KB, and a size of a file to be written in NV memory 11 is 10 KB. In this case, three area identifiers are required. Accordingly, file system unit 13 acquires the area identifier “0xF0000001” from the selected unused area management data set first, and then acquires two more area identifiers following the area identifier, i.e. “0xF0000002” and “0xF0000003.”

(2) When a file has been written to NV memory 11, areas where a file is written become used areas. Accordingly, file system unit 13 usually edits the selected unused area management data set so that areas identified by the selected unused area management data set do not contain the areas where the file is written.

For example, it is assumed that each unused area management data set contains an area identifier identifying a first area of a set of continuous unused areas and a size data set indicating a size of the set of continuous unused areas, in the same way as in the above explained case (1). In this case, area identifiers identifying unused areas are specified by a combination of an area identifier and a size data set contained in an unused area management data set. Accordingly, file system unit 13 updates the area identifier contained in the selected unused area management data set used for acquiring area identifiers in the above explained case (1) so that the acquired area identifiers are not contained in a set of continuous area identifiers starting from the updated area identifier.

For example, it is assumed that the selected unused area management data set contains an area identifier “0xF0000001” and a size data set indicating “80 KB.” It is also assumed that a size of an area is 4 KB. In this case, a set of continuous area identifiers “0xF0000001-0xF0000020” is specified by a combination of the area identifier and the size data set. It is also assumed that file system unit 13 acquired area identifiers “0xF0000001,” “0xF0000002,” and “0xF0000003” that identify unused areas where a file is to be written. In this case, file system unit 13 updates the area identifier in the selected unused area management data set from “0xF0000001” to “0xF0000004” so that the above-mentioned three area identifiers are not included in a set of continuous area identifiers specified by the selected unused area management data set. At the same time, file system unit 13 updates the size data set in the selected unused area management data set so that it indicates 68 KB that is equal to 80 KB deducted by 12 KB that is a size of three areas identified by the three area identifiers.

(3) When a file is deleted from NV memory 11, areas where the deleted file was written become unused areas. Accordingly, in this case, file system unit 13 usually updates an unused area management data set so that a set of unused areas specified by the unused area management data set should contain areas where the deleted file was written.

For example, it is assumed that each unused area management data set contains an area identifier identifying a first area of a set of continuous unused areas and a size data set indicating a size of the set of continuous unused areas, in the same way as in the above explained case (1). In this case, area identifiers identifying unused areas are specified by a combination of an area identifier and a size data set contained in an unused area management data set. Accordingly, file system unit 13 selects an unused area management data set, and updates an area identifier contained in the selected unused area management data set so that area identifiers should be included in a set of area identifiers specified by the selected unused area management data set. In this case, file system unit 13 selects, for example, an unused area management data set that contains an area identifier that is next to the area identifiers identifying the areas where the deleted file was written.

For example, it is assumed that the selected unused area management data set contains an area identifier “0xF0000004” and a size data set indicating “68 KB.” It is also assumed that a size of an area is 4 KB. In this case, a set of continuous area identifiers “0xF0000004-0xF0000020” is specified by a combination of the area identifier and the size data set. It is also assumed that file system unit 13 acquired area identifiers “0xF0000001,” “0xF0000002,” and “0xF0000003” that identify areas where a deleted file was written. In this case, the acquired three area identifiers are not included in the specified set of continuous area identifiers. Accordingly, file system unit 13 updates the area identifier in the selected unused area management data set to “0xF0000001” so that the above-mentioned three area identifiers are included in a set of continuous area identifiers specified by the selected unused area management data set. At the same time, file system unit 13 updates the size data set in the selected unused area management data set so that it indicates 80 KB that is equal to 68 KB added by 12 KB that is a size of three areas identified by the three area identifiers.

File system unit 13 may edit an unused management data set in response to writing of a file to NV memory 11, deletion of a file from NV memory 11, etc., in any procedures other than the above explained exemplary procedures so long as the unused management data set after the edit indicates a current status of unused areas of NV memory 11 after writing of a file, deletion of a file, etc.

Since file system unit 13 is a file system, it usually manages files stored in NV memory 11. Management of files includes writing a file to NV memory 11 in response to a request, reading out a file from NV memory 11 in response to a request, deleting a file from NV memory 11 in response a request, storing information (referred to as a “file management data set” hereinafter) for managing a file to file management information storage unit 132 when the file is written in NV memory 11, deleting a file management data set corresponding to a file from file management information storage unit 132 when the file is deleted from NV memory 11, storing an area identifier of an area storing no file to file management information storage unit 132, acquiring area identifiers of areas storing files from file management information storage unit 132 in response to a request, etc. A deletion of a file from NV memory 11 includes a deletion of a file management data set of a file without deleting the file, an addition of a flag indicating a deletion of a file to a file management data set without deleting the file, etc., as well as an actual deletion of a file.

File system unit 13 is a file system realized by an OS. Accordingly, management of files of file system unit 13 may include any function performed by a file system usually realized by an OS. The file system may be a virtual file system.

A file management data set indicates information for managing a file. A file management data set usually contains a file identifier and area identifiers. Namely, a file identifier is usually related to area identifiers. A file identifier is, for example, a file name described by a combination of letters and numbers. A file identifier is not limited with regard to its format so long as it identifies a file.

A file management data set may include data indicating attributes such as a file creation date, a file update date, access rights (permissions), a name of a user who created a file, etc. The data indicating attributes are related to the file identifier in the file management data set.

(1) When a file is written in NV memory 11, file system unit 13 first determines areas in which the file is written. In this embodiment, “to determine areas” usually means “to acquire one or more area identifiers identifying one or more unused areas in which a file is stored. File system unit 13 usually acquires one or more area identifiers by use of unused area management data sets as explained above. File system unit 13 divides the file into plural data parts, each of which is written in one of the areas if necessary. Then, file system unit 13 writes the file or the data parts of the file in the respective determined areas.

(2) After the file is written in NV memory 11, file system unit 13 stores a file management data set indicating a correspondence between a file identifier identifying the file written in NV memory 11 and area identifiers identifying the areas in which the file was written in file management information storage unit 132. Usually, the file management data set is newly added to file management data sets stored in file management information storage unit 132.

(3) When a file is read out from NV memory 11, file system unit 13 acquires area identifiers identifying areas in which the file is stored from a file management data set corresponding to the file. Then, file system unit 13 acquires the file or plural parts of the file from the areas identified by the acquired area identifiers.

(4) When a file is deleted from NV memory 11, file system unit 13 acquires area identifiers identifying areas in which the file is stored from a file management data set corresponding to the file. Then, file system unit 13 erases data stored in the areas identified by the acquired area identifiers. File system unit 13 may erase the file by deleting the file management data set without actually erasing the data.

When a file is deleted from NV memory 11, file system unit 13 may delete only a file management data set containing a file identifier identifying the file from file management information storage unit 132 without deleting data of the file from NV memory 11. File system unit 13 may delete a file by adding a flag indicating that the file is deleted to a file management data set containing a file identifier identifying the file instead of deleting the file management data set from file management information storage unit 132.

(5) When file system unit 13 deletes a file from NV memory 11, file system unit 13 usually deletes, from file management information storage unit 132, file management data sets containing a file identifier identifying the deleted file.

File system unit 13 may perform several processes that are performed by a well-known file system, explanations of which are omitted in this specification.

Unused area management information storage unit 131 stores unused area management data sets. Details of an unused area management data set are already explained earlier in this specification, and thus are not repeated here.

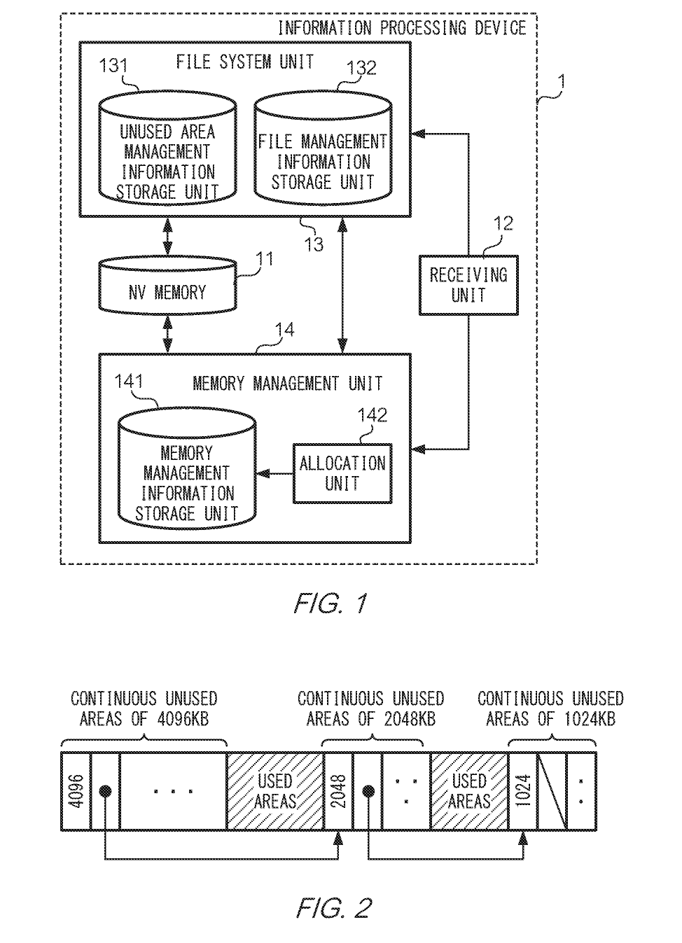

Unused area management information storage unit 131 is usually realized by areas of NV memory 11. Accordingly, unused area management data sets are usually stored in NV memory 11. For example, when an unused area management data set is configured in a data structure of a singly-linked list, an unused area management data set may be stored in NV memory 11 in a format such as that shown in FIG. 2. In the case shown in FIG. 2, plural sets of continuous unused areas are specified by an unused area management data set, and each set of continuous unused areas, that is specified by a combination of a first area identifier and a size data set, is associated with a pointer to a next set of continuous unused areas among the sets of continuous unused areas, i.e. a first area identifier of the next set of continuous unused areas.

File management information storage unit 132 stores one or more file management data sets. In the following description, one or more file management data sets may be referred to as a “file management data set group.” Details of a file management data set are already explained in the preceding part of this specification, and the explanation is not repeated here.

Memory management unit 14 performs so-called memory management. The memory management includes, for example, securing areas of NV memory 11 in response to a request from a running process, allocating the secured areas to the running process, releasing areas and changing statuses of the areas as unused when a process using the areas is terminated, etc.

In this specification, “to secure areas” means to acquire area identifiers identifying the areas.

A running process usually has a virtual address space. “To allocate areas to a process” usually means to map virtual addresses in a virtual address space of the process to area identifiers, or to allocate the area identifiers to the process. Physical addresses are usually used as area identifiers. When memory management unit 14 allocates areas to a process, it may map a process identifier identifying the process to area identifiers identifying the areas. When memory management unit 14 allocates areas to a process, it stores a data set indicating the correspondence between the process and the allocated areas (referred to as a “memory management data set” hereinafter) to memory management information storage unit 141. Allocation of areas may be expressed as area allocation, memory allocation, block allocation, page allocation, etc.

“To release areas from a process” usually means to remove a correspondence between virtual addresses of the process and area identifiers identifying the areas allocated to the process. When memory management unit 14 releases areas from a process, it deletes, from memory management information storage unit 141, a memory management data set indicating a correspondence between virtual addresses of the process and area identifiers of the areas allocated to the process.

A memory management data set indicates information used for managing areas of NV memory 11 allocated to a process. A memory management data set usually includes, at least, one or more virtual addresses and one or more physical addresses. (In the following description, “addresses” means “one or more addresses.”) The virtual addresses are respectively associated with the physical addresses. A process identifier identifying the process may be associated with the physical addresses instead of or in addition to the virtual addresses. A process name or a process number is usually used as a process identifier. However, any type of identifier may be used as a process identifier so long as a process is identified by the identifier.

Areas that may be secured for a process are areas that may also be used by file system unit 13 for storing a file. “Areas that may be used for storing a file” may be, for example, areas where a file may be written, areas where a file has been written, or areas storing data that may be treated as a file. The areas may be either unused areas or used areas. Memory management unit 14 usually secures areas for a process via file system unit 13. “To secure areas for a process via file system unit 13” means that file system unit 13 secures areas by acquiring one or more area identifiers.

Memory management unit 14 may perform several processes that are performed by a well-known memory manager, explanations of which are omitted in this specification. Memory management unit 14 usually performs processes such as securing areas for a process, allocating the secured areas to the process, releasing the allocated areas from the process, etc. by use of functional components that are explained later in this specification.

Memory management information storage unit 141 stores memory management data sets. Details of a memory management data set are already explained earlier in this specification, and they are not repeated here.

Allocation unit 142 allocates areas to a running process in response to a request from the process. Allocation unit 142 stores a memory management data set indicating a result of the allocation to memory management information storage unit 141.

For example, when allocation unit 142 receives a request for allocation of areas from a running process, allocation unit 142 usually acquires area identifiers indicating areas in which a file is written, from file system unit 13. Then, allocation unit 142 allocates to the process that made the request areas identified by the acquired area identifiers. This allocation method is referred to as “mmap method” in the following description in this specification.

In another allocation method, allocation unit 142 instructs, for example, in response to a request from a running process, file system unit 13 to write a file of the same size as that of areas requested by the process in NV memory 11. “To write a file” means to create a file. In response to the instruction, allocation unit 142 receives area identifiers identifying areas where the file is written from file system unit 13.

Receiving unit 12 may acquire in various ways information such as an instruction input by a user, such as a via a menu screen, a keyboard, etc. Namely, receiving unit 12 may be realized by a program for controlling a menu screen, a device driver for a data input device such as a keyboard, etc.

File system unit 13, memory management unit 14, and allocation unit 142 are usually realized by a processor such as MPU, memory, etc. Procedures performed by the above components of information processing device 1 such as file system unit 13 are usually instructed by programs. The programs may be provided in a form being recorded in a recording medium such as a ROM. Alternatively, the above components of information processing device 1 such as file system unit 13 may be realized by hardware such as circuits designed for the components.

Unused area management information storage unit 131, file management information storage unit 132, and memory management information storage unit 141 are usually realized by areas of NV memory 11. Alternatively, unused area management information storage unit 131, etc., may be realized by a memory other than NV memory 11, which is either a non-volatile memory or a volatile memory. Unused area management information storage unit 131, etc., may acquire data through various routes, such as a recording medium recording the data, a communication line for transmitting the data, an input device for receiving data input by a user, etc.

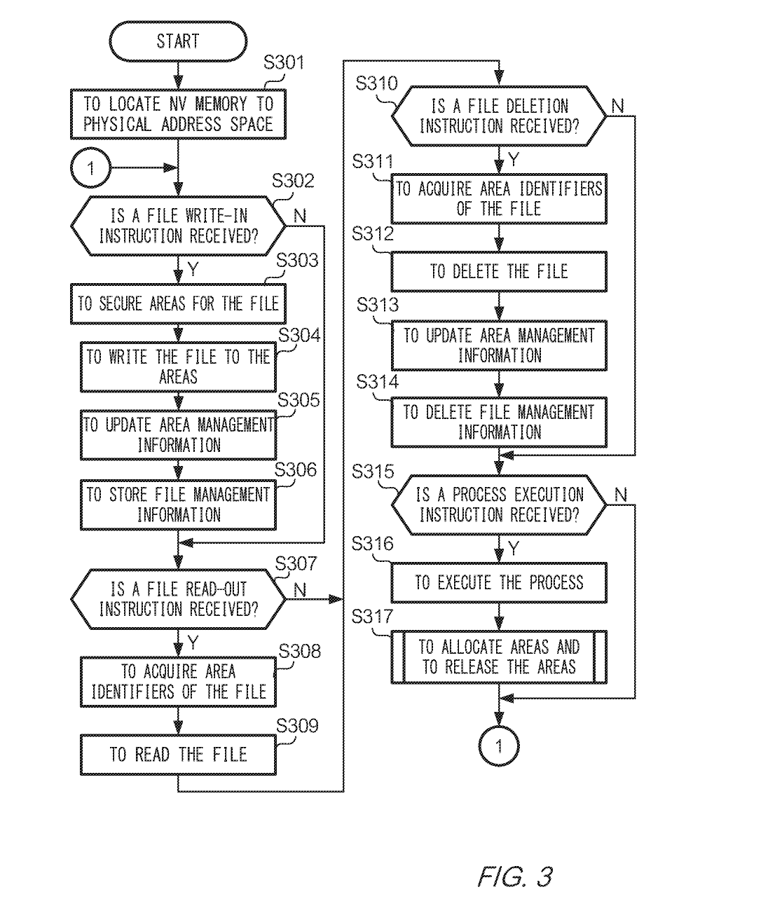

Operations of information processing device 1 are explained below with reference to flowcharts. FIG. 3 is a flowchart showing a series of procedures carried out by information processing device 1. In the flowcharts, including that of FIG. 3, that are referred to in the following explanation, a judging procedure is shown in a box of hexagonal shape instead of a box, due to limited space, instead of a box of rhomboidal shape defined by JIS (Japanese Industrial Standards).

(Step S310) File system unit 13 disposes NV memory 11 in a physical address space. The disposal may be performed by memory management unit 14 instead of file system unit 13.

(Step S302) File system unit 13 judges whether or not receiving unit 12 receives a file write-in instruction. A file write-in instruction instructs writing of a file in NV memory 11. A file write-in instruction usually contains a file identifier and a data set indicating contents of the file. If receiving unit 12 receives a file write-in instruction, step S303 is carried out next; otherwise, step S307 is carried out next.

(Step S303) File system unit 13 secures areas for writing the file. More concretely, file system unit 13 acquires area identifiers by use of unused area management data sets stored in unused area management information storage unit 131.

(Step S304) File system unit 13 writes the file in areas identified by the area identifiers acquired in step S303.

(Step S305) File system unit 13 updates the unused area management data sets so that areas identified by the area identifiers acquired in step S303 are not included in unused areas identified by the unused area management data sets.

(Step S306) File system unit 13 associates the area identifiers acquired in step S303 with a file identifier identifying the file written in the areas in step S304 to create a file management data set, and stores the file management data set in file management information storage unit 132.

(Step S307) File system unit 13 judges whether or not receiving unit 12 receives a file read-out instruction. A file read-out instruction instructs reading of a file from NV memory 11. A file read-out instruction usually contains a file identifier. If receiving unit 12 receives a file read-out instruction, step S308 is carried out next; otherwise, step S310 is carried out next.

(Step S308) File system unit 13 acquires, from file management information storage unit 132, area identifiers identifying areas that store the file to be read out.

(Step S309) File system unit 13 reads out the file from areas identified by the area identifiers acquired in step S308.

(Step S310) File system unit 13 judges whether or not receiving unit 12 receives a file deletion instruction. A file deletion instruction instructs deletion of a file from NV memory 11. A file deletion instruction usually contains a file identifier. If receiving unit 12 receives a file deletion instruction, step S311 is carried out next; otherwise, step S315 is carried out next.

(Step S311) File system unit 13 acquires, from file management information storage unit 132, area identifiers identifying areas that store the file to be deleted.

(Step S312) File system unit 13 deletes the file from the area identified by the area identifiers acquired in step S311.

(Step S313) File system unit 13 updates the unused area management data sets so that areas identified by the area identifiers acquired in step S311 are included in unused areas identified by the unused area management data sets.

(Step S314) File system unit 13 deletes a file management data set containing the area identifiers acquired in step S311 from file management information storage unit 132.

(Step S315) Memory management unit 14 judges whether or not receiving unit 12 receives a process execution instruction. A process execution instruction instructs execution of a process. A process execution instruction usually contains a process identifier. If receiving unit 12 receives a process execution instruction, step S316 is carried out next; otherwise, step S302 is carried out next.

(Step S316) Information processing device 1 executes the process.

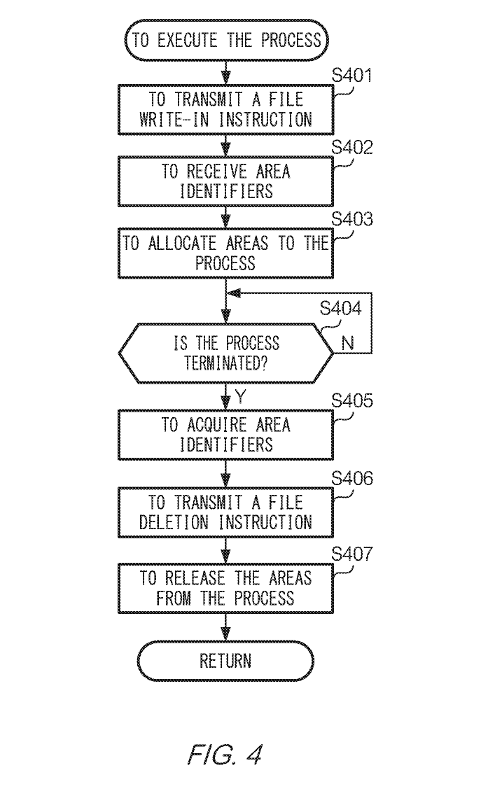

(Step S317) Memory management unit 14 allocates areas to the running process and release the areas allocated to the running process. Details of the procedure carried out in step S317 will be explained later with reference to a flowchart shown in FIG. 4. Then, step S302 is carried out next.

The above-explained procedure flow shown in FIG. 3 may be terminated at any time because of, for example, a cut-off of power supply, an interrupting process, etc.

FIG. 4 is a flowchart showing a series of procedures for allocating areas to the process and procedures for releasing areas allocated to the process carried out in step S317 of FIG. 3.

(Step S401) Allocation unit 142 generates a file write-in instruction to write a file of the size requested from the process, and transmits the file write-in instruction to file system unit 13.

(Step S402) Allocation unit 142 receives area identifiers identifying areas where the file is written from file system unit 13.

(Step S403) Allocation unit 142 allocates areas identified by area identifiers received in step S402 to the process that made the request. More concretely, allocation unit 142 usually stores a memory management data set indicating a result of the allocation to memory management information storage unit 141.

(Step S404) Memory management unit 14 judges whether or not the process is terminated. If the process is terminated, step S405 is carried out next; otherwise, step S404 is repeated.

(Step S405) Allocation unit 142 acquires area identifiers that identify areas that are allocated to the terminated process from memory management information storage unit 141.

(Step S406) Allocation unit 142 generates a file deletion instruction to delete a file written in areas identified by the area identifiers acquired in step S405, and transmits the file deletion instruction to file system unit 13.

(Step S407) Allocation unit 142 releases the area identifiers acquired in step S405 from the process that made the request for allocation of the areas. More concretely, allocation unit 142 usually deletes a memory management data set that contains the area identifiers acquired in step S405 from memory management information storage unit 141. Then, information processing device 1 returns to the flow shown in FIG. 3 and step S302 is carried out next.

### EXAMPLES

Some exemplary operations of information processing device 1 are explained below. In the following exemplary operations, it is assumed that NV memory 11 is disposed in a physical address space, and a size of each area of NV memory 11 is 4 KB.

### Example 1

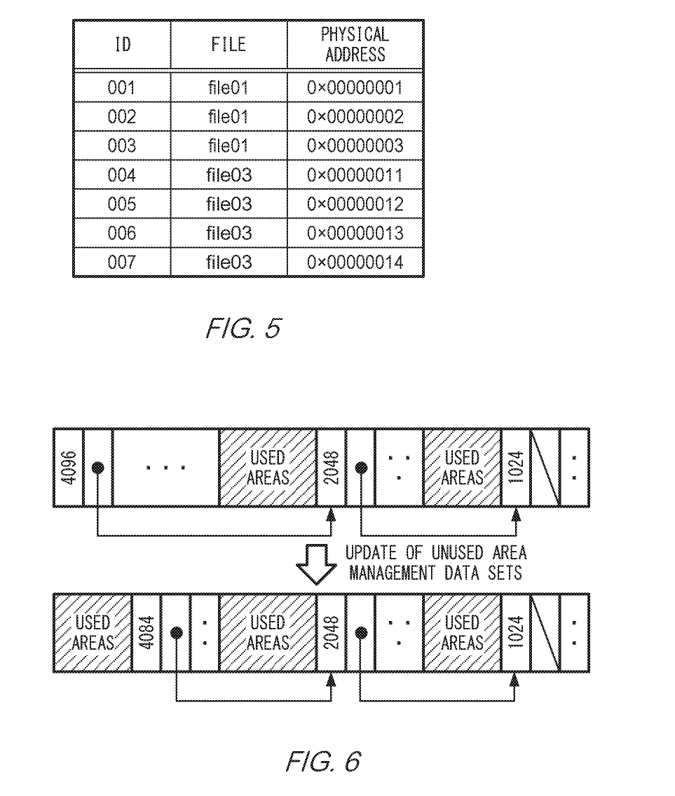

An exemplary operation of information processing device 1 where areas are allocated to a process in the mmap method is explained below as example 1. In example 1, it is assumed that unused area management information storage unit 131 stores unused area management data sets shown in FIG. 2. It is also assumed that file management information storage unit 132 stores file management data sets shown in FIG. 5. Each of the file management data sets shown as a data record in the data table shown in FIG. 5 contains an ID identifying the data record, a file identifier (identified by a data field name “file”) and a physical address. A physical address contained in a file management data set functions as an area identifier. The file management data sets shown in FIG. 5 indicate that, for example, a file identified by a file identifier “file01” is stored in three areas identified by physical addresses “0x00000001,” “0x00000002” and “0x00000003.”

It is assumed that a user performs operations for instructing information processing device 1 to execute a program. In this case, receiving unit 12 receives a process execution instruction to instruct the program to be executed as a process. It is assumed that the received process execution instruction contains a process identifier “proc01.” In this case, information processing device 1 executes a program identified by the process identifier as a process.

Then, it is assumed that the running process requests areas of 10 KB. In this case, receiving unit 12 receives an area allocation instruction to allocate areas to the process. The area allocation instruction contains the process identifier “proc01” and a data set indicating the requested size of areas “10 KB.”

Allocation unit 142 generates a file write-in instruction to write a file of 10 KB to NV memory 11, and transmits the file write-in instruction to file system unit 13. The file write-in instruction contains a data set indicating the size of file, i.e. “10 KB.”

Receiving unit 12 receives the file write-in instruction. File system unit 13 acquires a file identifier following the file write-in instruction. File system unit 13 acquires physical addresses indicating unused areas of a number conforming to the size of the file, i.e. “10 KB” by use of the unused area management data sets stored in unused area management information storage unit 131. It is assumed that file system unit 13 acquires file identifier “file99” and physical addresses “0x00000004,” “0x00000005” and “0x00000006.”

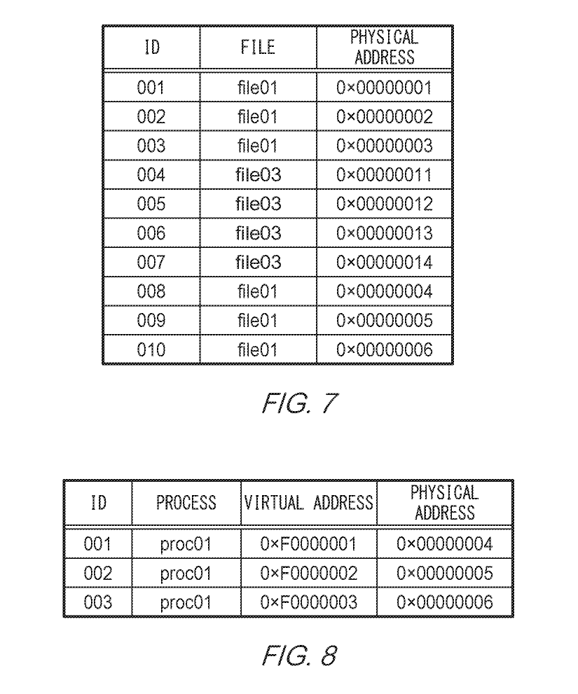

Next, file system unit 13 writes a file in the areas identified by the acquired physical addresses. Then, file system unit 13 updates unused area management data sets stored in unused area management information storage unit 131 so that unused areas specified by the unused area management data sets do not include the three areas where the file was written. FIG. 6 illustrates an example of status change of an unused area management data set. Then, file system unit 13 generates file management data sets indicating a result of the writing of a file, and stores the file management data sets in file management information storage unit 131. Namely, file system unit 13 adds the new file management data sets to the file management data sets shown in FIG. 5. FIG. 7 shows the file management data sets after the addition of new file management data sets. Details of format of the file management data sets are not repeated here.

File system unit 13 transmits, to memory management unit 14, the physical addresses identifying the areas where the file is written.

Next, allocation unit 142 receives physical addresses “0x00000004,” “0x00000005” and “0x00000006.” Allocation unit 142 allocates the areas identified by the physical addresses to the process identified by process identifier “proc01.” Then, allocation unit 142 stores memory management data sets indicating a result of the allocation in memory management information storage unit 141. FIG. 8 shows the stored memory management data sets.

When the running process identified by process identifier “proc01” is terminated, allocation unit 142 acquires, from the memory management data sets shown in FIG. 8, physical addresses “0x00000004,” “0x00000005” and “0x00000006” corresponding to process identifier “proc01.”

Allocation unit 142 generates a file deletion instruction to delete a file written in areas identified by the acquired three physical addresses, and transmits the file deletion instruction to file system unit 13. It is assumed that the file deletion instruction contains the three physical addresses, i.e. “0x00000004,” “0x00000005,” and “0x00000006.”

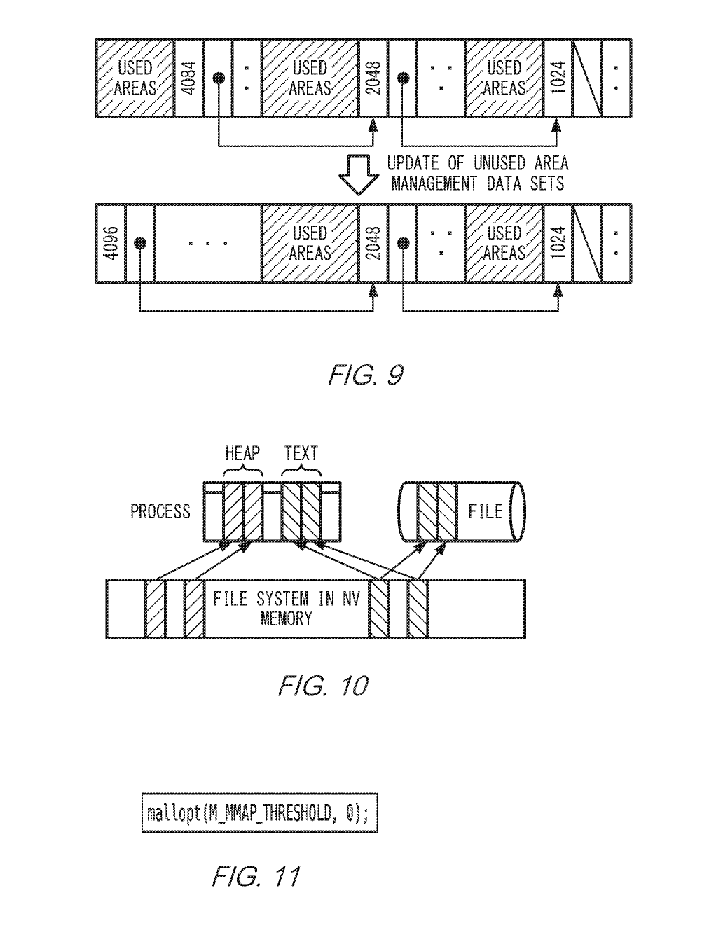

Receiving unit 12 receives the file deletion instruction. File system unit 13 deletes a file written in areas of the physical addresses contained in the file deletion instruction in accordance with the file deletion instruction. Then, file system unit 13 updates unused area management data sets stored in unused area management information storage unit 131 so that unused areas specified by the unused area management data sets include the three areas from which the file was deleted. FIG. 9 illustrates an example of status change of an unused area management data set. File system unit 13 deletes file management data sets containing the three physical addresses of the areas from which the file was deleted from the file management data sets shown in FIG. 7. After the deletion, the file management data sets become as shown in FIG. 5.

Then, allocation unit 142 deletes the memory management data sets shown in FIG. 8 from memory management information storage unit 141.

### Example 2

Now, an exemplary configuration of information processing device 1 is explained below. In this example, NV memory 11 may be referred to as an “NV memory.” Information processing device 1 is, for example, realized by a kernel of Linux (“Linux” is a registered trademark in Japan).

FIG. 10 shows an exemplary configuration of information processing device 1. Information processing device 1 shown in FIG. 10 is a system where an NV memory and a file system are integrated. Information processing device 1 manages areas of the NV memory by use of the file system for the purpose of using areas of the NV memory as both a storage and a main memory without separating the areas of NV memory into areas for the storage and for the main memory. When a file is stored in the NV memory by use of the file system, blocks are allocated for storing data of the file using a known method. Data contained in the file such as a program text can be directly accessed as data memorized in the main memory in a method such as XIP. When more free memory space is required, free blocks are acquired from the file system. The process shown in FIG. 10 maps a file of a text to the NV memory by XIP, and with regard to heap areas, it acquires free blocks and maps the free blocks as heap areas to the NV memory. In this example, both free memory areas and free blocks are unused areas of the NV memory.

Next, an implementation of the mmap method is explained below. In the mmap method, mmap system calls (referred to as “mmap”) are used for securing blocks from the file system and for allocating areas to a process. Accordingly, there is no need to modify the kernel of file system to implement the mmap method. When area allocation is performed in the mmap method, mmap system calls are used in a program. In most existing programs, “malloc( )” is used for allocating areas to a process. However, in a standard C library “GNU Libc” normally used in Linux (“Linux” is a registered trademark in Japan), heap areas are allocated to a process when a requested size is comparatively small, and areas secured by “mmap” are allocated to a process when a requested size is comparatively large. In a standard C library “GNU Libc,” it is possible to use only “mmap” for allocating areas to a process by setting the threshold value for judging whether a requested size is small or large, as shown in FIG. 11, without modifying the library.

### Example 3

Some experimental results of checking performances of information processing device 1 realized by the configurations explained above as example 2 are explained below.

First, results of experiments for comparing costs required for allocating areas to a process are explained below.

### (Conditions of Experiments)

A system that uses an NV memory as a main memory is not available. Accordingly, in this experiment, differences in access delays between an NV memory and a DRAM, and a constraint of rewriting times in an NV memory are not taken into account, and a part of a DRAM is deemed to be an NV memory. A personal computer having a processor identified as “Intel Atom D2700 2.13 GHz” is used for the experiment. The hyper-threading function is invalidated by the BIOS, and performance is measured under a single CPU mode. A size of the DRAM of the personal computer is 8 GB, and the lower area of 4 GB of the DRAM is deemed as an NV memory. Parameter “mem=128M” is passed to the kernel for limiting areas of DRAM recognized by the kernel, and performance is measured under a condition that only 128 MB areas of the DRAM are recognized by the kernel. However, in a control experiment referred to as “DRAM method” in this example, the above explained settings for dividing areas of DRAM are not used.

### (Results of Experiments)

For measuring a cost for allocating areas to a process, a program was developed. The program secures areas of a number meeting with a size appointed as a parameter, and writes data in the top page of each of the secured areas. A measured cost includes only a cost for allocating areas to a process, and it does not include a cost for releasing the allocated areas from the process. Costs were measured by use of the program in the DRAM method, the direct fusion method, semi-direct fusion method, indirect fusion method with the secured in-advance method, indirect fusion method with the secure on-demand method, and the mmap method. The program was executed with each of two file systems, i.e. Ext2 and PRAMFS, except the program was executed for measuring a cost for allocating areas to a process in the DRAM method.

The direct fusion method is a method in which a requested size of areas of the NV memory are directly allocated to a process without using the file system. The semi-direct fusion method is a method in which a requested size of areas of the NV memory are added to a file that is managed by the file system, and the added areas are allocated to a process. The indirect fusion method with the secured in-advance method is a method in which all areas of the NV memory storing files managed by the file system are secured for allocation to processes before a request for allocation of areas is made, and the secured areas are allocated to a process when the request is made. The indirect fusion method with the secure on-demand method is a method in which areas of the NV memory storing a file managed by the file system are secured for allocation to a process each time that a request for allocation of areas is made by a process. Detailed explanation of these methods are omitted here.

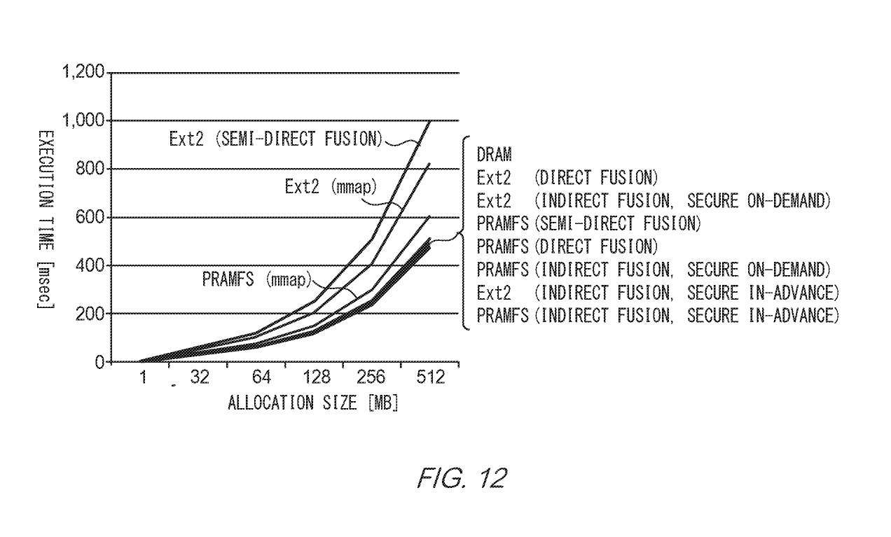

FIG. 12 shows results of the experiments. The horizontal axis indicates allocation sizes (MB), and the vertical axis indicates execution times (msec) each of which is calculated by dividing a value measured by an RDTSC (Read Time Stamp Counter) by the clock frequency.

The results of experiments shown in FIG. 12 indicate the following matters:

(1) A cost in the semi-direct fusion method with Ext2 is the highest.

(2) A cost in the mmap method is comparatively high both with Ext2 and PRAMFS.

(3) A cost in the indirect fusion method with the secure in-advance method is the lowest.

In the case shown in FIG. 12, when PRAMFS is used, in comparison with the cost of the indirect fusion method with the secure in-advance method, the costs of the direct fusion method, the semi-direct fusion method, the indirect fusion method with the secure on-demand method and the mmap method are 2.3% higher, 2.5% higher, 1.2% higher and 27.9% higher respectively. When Ext2 is used, they are 5.2% higher, 111.5% higher, 3.2% higher and 73.6% higher, respectively. In the indirect fusion method with the secure on-demand method, each time a request for areas of a larger size than a size of available blocks is made, blocks are allocated to a file. However, in the indirect fusion method with the secure on-demand method, once blocks are allocated to a file, the blocks are reused after they are released under the management performed by use of the free list, and therefore, influence on a cost caused by allocations of blocks is limited. In the semi-direct fusion method, influence on a cost caused by allocations of blocks is limited when PRAMFS is used, but the influence is considerable when Ext2 is used. When the semi-direct fusion method is carried out with Ext2, redundant procedures are executed for allocating blocks and releasing the blocks as explained above. It is believed that this is the reason the influence on a cost caused by allocations of blocks is considerable when the semi-direct fusion method is carried out with Ext2. The most remarkable difference between the mmap method and the other methods exists in the procedures for securing blocks from the file system. In the indirect fusion method, only one block is acquired from the free list when a request for areas is made. In the direct fusion method, each time the free list becomes empty, plural blocks are secured from the file system collectively. In the mmap method, each of plural blocks is individually secured from the file system each time a request for areas is made. The results of experiments show that a cost for allocating areas is influenced by a cost for securing blocks from the file system, and a cost is reduced remarkably when blocks are secured collectively.

Next, results of experiments for measuring how a method for managing free areas influences a cost for allocating areas to a process are explained below.

In accordance with the results of experiments shown in FIG. 12, it is found that a cost for securing blocks from the file system has a major influence on a cost for allocating areas to a process. Especially in the mmap method, a method for managing free areas used by the file system has a major influence on a cost for allocating areas to a process since each of blocks is secured individually in the mmap method. Accordingly, experiments were carried out using PRAMFS that has a comparatively simple internal structure and modified PRAMFS whose structure for managing free areas in the file system is modified to be more appropriate for handling areas of the memory to decrease a cost for securing blocks.

In the direct fusion method and the indirect fusion method, procedures required for securing a block from the file system include only acquiring an element from the free list. In the mmap method, blocks are secured by use of a function of managing free areas of the file system. In PRAMFS, free areas are managed by use of a bit map, and a procedure of searching bits indicating free areas from the bit map increases a cost for allocating areas to a process. When a HDD with a comparatively long seek time is used, free blocks are not usually managed by use of a free list since the free list promotes fragmentation of data. A method for managing free blocks using a free list is used in many file systems, since once a free block is found, another free block neighboring the found free block is found quickly using the method, and fragmentation of data is not promoted by the bit map. However, when an NV memory with no seek time is used by the file system, there is no merit in using a bit map for managing free areas since searching free areas by use of a bit map is costly, as mentioned above.

Accordingly, if the method of using a free list is adopted instead of the method of using a bit map for managing free areas in the file system using an NV memory, it is assumed that a cost for allocating areas to a process is reduced, especially when the mmap method is used. For the purpose of verifying the assumption, a modified version of PRAMFS that uses a free list for managing free areas instead of a bit map was developed. When the modified PRAMFS is used as the file system, blocks are secured from the file system in the mmap method at substantially the same cost as in the indirect fusion method. Moreover, when the modified PRAMFS is used as the file system, there is no need to maintain a bit map whose data size is comparatively large, and more areas become available for storing data.

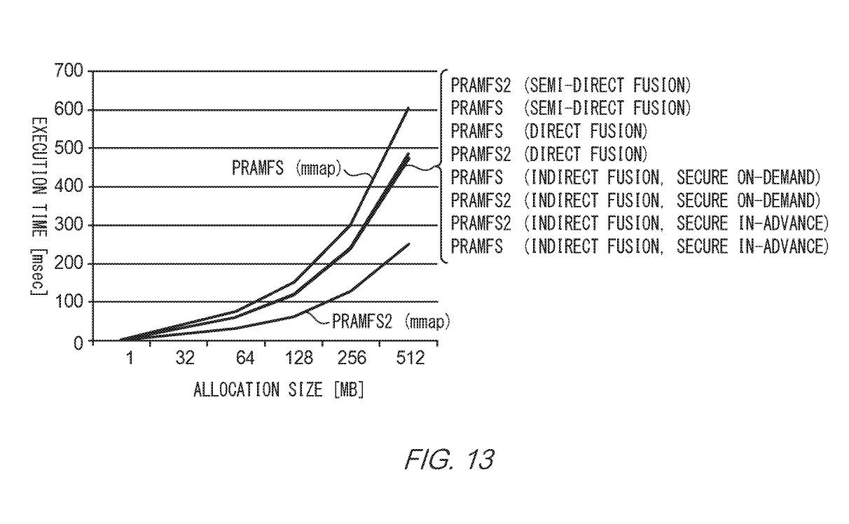

FIG. 13 shows results of the experiments for measuring costs for allocating areas to a process in each of the methods for allocating areas to a process. The same program as used in the other experiments, explained above, was used for the experiments. In FIG. 13, the modified PRAMFS using a free list for managing free areas is referred to as “PRAMFS2.” Because of cost reduction caused by the change of methods for managing free areas, a cost for allocating areas to a process when the mmap method is used is reduced by 58.2%. On the other hand, the replacement of methods for managing free areas does not have any substantial influence on a cost for allocating areas to a process when methods other than the mmap method are used.

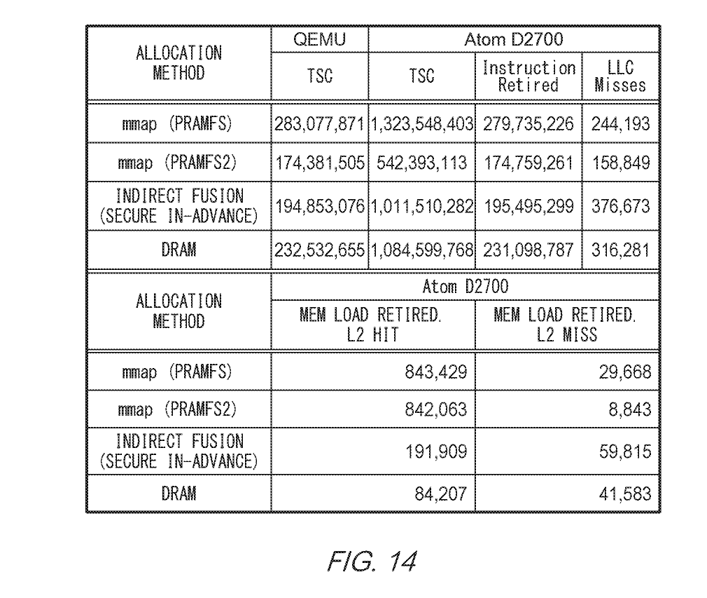

In the case shown in FIG. 13, after a cost for allocating areas to a process in the mmap method is remarkably reduced because of the replacement of a bit map with a free list, the cost of the mmap method is 46.8% less than that of the indirect fusion method with the secured in-advance method, and the mmap method becomes the least costly method. For the purpose of verifying the reason that such a remarkable reduction of cost is achieved, a number of instructions and a number of cache misses were measured by use of Performance Monitoring Counter (PMC). A number of instructions was also measured in the environment of QEMU. FIG. 14 shows results of the measurements. In FIG. 14, TSC (Time Stamp Counter) of QEMU indicates a number of instructions, but TSC of Atom indicates an execution time. In FIG. 14, “instruction retired” indicates a number of instructions, “LLC (Last Level Cache) Misses” indicates a total number of L2 cache misses, “MEM LOAD RETIRED. L2 HIT” indicates a number of orders to load data that was missed in L1 cache and hit in L2 cache, and “MEM LOAD RETIRED. L2 MISS” indicates a number of orders to load data that was missed in L2 cache.

In the case shown in FIG. 14, the numbers of instructions of QEMU and those of Atom are not identical to each other, since they may be affected by interrupt instructions, but they are similar to each other. A cost measured by a number of instructions is also reduced in the mmap method because of the replacement of a bit map with a free list for managing free areas, but the degree of reduction of the cost is 37.5%, which is less than a cost measured by an execution time. It is believed that reduction of a number of cache misses is one of the reasons an execution time is remarkably reduced because of the replacement of a bit map with a free list. In FIG. 14, both in values of “LLC Misses” and “MEM LOAD RETIRED. L2 MISS,” remarkable improvements are recognized. A size of L2 cache of “Atom D2700” is 512 KB per core, and the size is comparatively small even compared to a size of L2 cache of a popular processor for a notebook PC. Accordingly, it is assumed that data is acquired from the cache of Atom when the method for managing free areas uses a free list more frequently than when the method for managing free areas uses a bit map, which causes the high degree of reduction in execution time. The same experiments were carried out by use of “Xeon E3-1270” with L3 cache of 8 MB, and a cost for allocating areas to a process was reduced by 26.0%. The result of the experiments indicates that a cost is affected by a size of cache.

In accordance with the above-explained experiments, it is confirmed that a performance of a file system managing files stored in an NV memory can be improved by tuning its internal structures, since the file system has been tuned for managing files stored in a HDD, and a method of managing free areas is one of the components that should be tuned.

According to information processing device 1 of the present embodiment, when an NV memory is used both as a main memory and a storage, time required for allocating memory blocks to a process can be shortened.

In each of the above-explained examples, the explained procedures and the explained functions may be implemented by a centralized single device or a centralized single system. Alternatively, the explained procedures and the explained functions may be implemented by distributed plural devices or distributed plural systems.

In each of the above-explained examples, each of the explained components of information processing device 1 may be configured by hardware designed for the component. Alternatively, with regard to components that may be realized by software, they may be realized by executing a program. In this case, a program execution unit such as a CPU reads a program from a recording medium such as a hard disk and a semiconductor memory, and executes the program to realize the component.

The program realizing the information processing device according to each of the above-explained examples may be a program as explained below. Namely, the program is a program for causing a computer that is capable of accessing an NV memory as a non-volatile recording medium to function as: a file system unit that manages one or more files stored in the NV memory, and a memory management unit that secures one or more areas of the NV memory that are ready to be used by the file system unit to store a file and allocates the secured one or more areas to a running process in response to a request from the running process, wherein the file system unit accesses areas of the NV memory storing unused area management data sets for managing unused areas of the NV memory, the unused area management data sets having data structure that is suitable for characteristic features of the NV memory, and the data structure that is suitable for characteristic features of the NV memory is configured for using areas of the NV memory that are not physically continuous as areas that are logically continuous.

The functions realized by the above-explained program do not include any function that is realized only by hardware.

The above-explained program may be downloaded from a server to the computer, and executed in the computer. Alternatively, the program may be recorded in a recording medium such as an optical disk such as a CD-ROM, a magnetic disk and a semiconductor memory, read from the recording medium by the computer, and executed by the computer. The program may be used as a component of a program product.

A computer that executes the above-explained program may be either a single device or a group of plural devices. Namely, the processes executed by the computer may be either centralized or distributed.

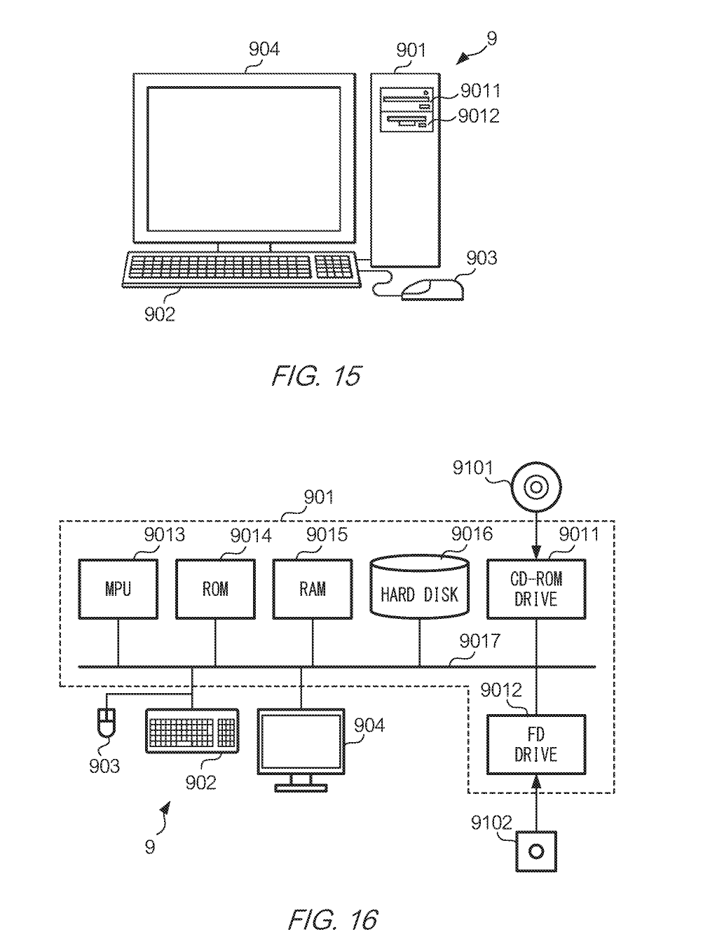

FIG. 15 shows a configuration of computer system 9 that realizes the above-explained information processing device by executing the above-explained program. Each of the above-explained examples may be realized by a combination of a computer (hardware) and a program (software) that is executed by the computer.

As shown in FIG. 15, computer system 9 comprises computer 901 having CD-ROM drive 9011 and FD drive 9012, keyboard 902, mouse 903 and monitor 904.

FIG. 16 shows a block diagram of computer system 9. As shown in FIG. 16, computer 901 comprises MPU 9013, ROM 9014, RAM 9015, hard disk 9016 and bus 9017 in addition to CD-ROM drive 9011 and FD drive 9012. ROM 9014 stores programs such as a boot-up program. RAM 9015 is connected with MPU 9013. RAM 9015 temporarily stores instructions made by an application program, as well as providing a temporary memory space for the application program. Hard disk 9016 stores application programs, system programs and various types of data sets. Bus 9017 connects the components of computer 901 such as CD-ROM drive 9011, FD drive 9012 and MPU 9013 with each other. Computer 901 may further have a network interface (not shown in FIG. 16) that provides a connection to a LAN.

The program that causes computer system 9 to function as the information processing device according to the above-explained embodiment may be recorded in CD-ROM 9101 or FD 9102 that may be inserted into CD-ROM drive 9011 or FD drive 9012, respectively, and read from CD-ROM 9101 or FD 9102 to be transferred to hard disk 9016. Alternatively, the program may be transmitted from an external device via a network (not shown in FIG. 20) to computer 901, and stored in hard disk 9016. When the program is executed, it is loaded to RAM 9015. Alternatively, the program may be loaded to RAM 9015 directly from CD-ROM 9101, FD 9102, or an external device via the network.

The program may not include an operating system (OS), a program provided from a third party, or the like that causes the information processing device according to the above-explained embodiment to implement standard functions. Namely, the program may include only instructions to call necessary functions or modules from the OS or the like in a controlled way so that a desired result is achieved. Computer system 9 operates in the same way as a popular computer system, and details of the operation are not explained here.

The present invention should not be limited by the above-explained embodiment, and it may be modified in various ways. These modifications also fall within the scope of the present invention.

As explained above, according to the information processing device of the present invention, when an NV memory is used both as a main memory and a storage, time required for allocating memory blocks to a process may be shortened, and it is useful, for example, as a function of an operating system.

### DESCRIPTION OF REFERENCE NUMERALS

1 . . . Information processing device

11 . . . NV memory

12 . . . Receiving unit

13 . . . File system unit

14 . . . Memory management unit

131 . . . Unused area management information storage unit

132 . . . File management information storage unit

141 . . . Memory management information storage unit

142 . . . Allocation unit

What is claimed is:

1-5. (canceled)

6. An information processing device comprising:
an NV memory that is a non-volatile recording medium;
a file system unit that manages one or more files stored in the NV memory, and
a memory management unit that secures one or more areas of the NV memory that are ready to be used by the file system unit to store a file, and allocates the secured one or more areas to a running process in response to a request from the running process,
wherein:
the file system unit accesses areas of the NV memory storing unused area management data sets for managing unused areas of the NV memory, the unused area management data sets having data structure that is suitable for characteristic features of the NV memory, and
the data structure that is suitable for characteristic features of the NV memory is configured for using areas of the NV memory that are not physically continuous as areas that are logically continuous.

7. The information processing device according to claim 6, wherein the data structure contains list structure or data structure using list structure for managing memory.

8. The information processing device according to claim 6, wherein:
the file system unit writes a file of a size conforming to a size requested by the running process to unused areas of the NV memory in response to the request from the running process, and
the memory management unit allocates the unused areas of the NV memory where the file is written by the file system unit to the running process in response to the request from the running program.

9. An information processing method using an NV memory that is a non-volatile recording medium, a file system unit and a memory management unit, the method comprising:
a step for the file system unit to manage one or more files stored in the NV memory, and
a step for the memory management unit to secure one or more areas of the NV memory that are ready to be used by the file system unit to store a file, and allocate the secured one or more areas to a running process in response to a request from the running process;
wherein:
in the step for the file system unit to manage one or more files, the file system unit accesses areas of the NV memory storing unused area management data sets for managing unused areas of the NV memory, the unused area management data sets having data structure that is suitable for characteristic features of the NV memory, and
the data structure that is suitable for characteristic features of the NV memory is configured for using areas of the NV memory that are not physically continuous as areas that are logically continuous.

10. A program for causing a computer that is capable of accessing an NV memory that is a non-volatile recording medium to function as:
a file system unit that manages one or more files stored in the NV memory, and
a memory management unit that secures one or more areas of the NV memory that are ready to be used by the file system unit to store a file, and allocates the secured one or more areas to a running process in response to a request from the running process,
wherein:
the file system unit accesses areas of the NV memory storing unused area management data sets for managing unused areas of the NV memory, the unused area management data sets having data structure that is suitable for characteristic features of the NV memory, and
the data structure that is suitable for characteristic features of the NV memory is configured for using areas of the NV memory that are not physically continuous as areas that are logically continuous.
